(19) United States
(12) Patent Application Publication
(10) Pub. No.: US 2003/0067779 A1
(43) Pub. Date: Apr. 10, 2003

(54) Adjustable hanger support for ceiling fan assembly

(76) Inventor: Po Kung Lo, Taichung Hsien (TW)

Correspondence Address: Po Kung Lo, P.O. Box 196, Fung Yung, Taichung, 420, TW

(21) Appl. No.: 09/972,654

(22) Filed: Oct. 9, 2001

(51) Int. Cl. F21S 8/06

(52) U.S. Cl. 362/404

(57) ABSTRACT

A ceiling fan device includes a ceiling fan housing, a bracket for attaching to a ceiling of a building and having a socket and a projection extended inward of the socket, a downrod having a lower end secured to the ceiling fan housing and an upper end secured to a ball. The ball includes two or more slots formed in the outer peripheral portion for selectively receiving the projection of the bracket and for adjusting the ball and the ceiling fan housing and the light device and the patterns of the fan housing relative to the bracket and the ceiling and the walls.

### BACKGROUND OF THE INVENTION

1. Field of the Invention

The present invention relates to a hanger support, and more particularly to an adjustable hanger support for adjustably supporting and securing the ceiling fan assembly to the required angular position relative to the housings or buildings.

2. Description of the Prior Art

Typical hanger supports for the ceiling fan devices are shown in FIGS. 1-3, and comprise a bracket 1 including two ears 2 extended laterally outward therefrom and each having an oblong hole 3 formed therein for receiving fasteners which may secure the bracket 1 to the ceiling of the housings or of the buildings. The bracket 1 includes a ring or a socket 4 formed or provided in the bottom portion thereof, and includes a projection 7 extended inward of the ring or the socket 4.

A downrod 5 includes a lower end secured to a ceiling fan housing 9 and includes a ball 6 secured on top thereof. The ball 6 includes a slot 8 formed in the outer peripheral portion thereof and extended from the upper portion toward the lower portion thereof for receiving the projection 7 of the socket 4 and for preventing the ball 6 and thus the ceiling fan housing 9 from rotating relative to the bracket 1 and the ceiling in a plane parallel to the bracket 1 and the ceiling of the housing or the building, and for allowing the ball 6 and the downrod 5 to be rotated and adjusted relative to the bracket 1 in a plane perpendicular to the bracket 1 or the ceiling or the like.

However, the ball 6 includes a single slot 8 formed therein for receiving the projection 7 of the socket 4, such that the ball 6 and thus the ceiling fan housing 9 may not be rotated and adjusted relative to the bracket 1 and the ceiling in the plane parallel to the bracket 1 and the ceiling of the housing or the building, and such that the patterns 90 provided on the outer peripheral portion of the ceiling fan housing 9 may not be suitably adjusted and directed toward the required angular position relative to the housings or the buildings, particularly relative to the side walls of the housings or the buildings.

For example, the ceiling fan assembly may include a number of light devices of lamp shades attached thereto, or may include a light device for shining onto the patterns 90 provided on the outer peripheral portion of the ceiling fan housing 9 and for shining the patterns 90 onto the respective walls of the housing or of the building. When the lamp shades or the patterns 90 are not directed toward the walls, the lights or the patterns may not be shined onto the walls and may be shined onto the corners of the housing or of the building, such that the patterns 90 may not be adequately and plainly and flatly and smoothly shown on the walls. In addition, the lights from the light device may not be adjusted or rotated or moved or directed toward the required angular position according to the users' need.

The present invention has arisen to mitigate and/or obviate the afore-described disadvantages of the conventional hanger supports for ceiling fans.

### SUMMARY OF THE INVENTION

The primary objective of the present invention is to provide an adjustable hanger support for adjustably and suitably supporting and securing the ceiling fan assembly to the required angular position relative to the housings or the buildings.

In accordance with one aspect of the invention, there is provided a ceiling fan assembly comprising a ceiling fan housing, a bracket for attaching to a ceiling of a building, the bracket including a socket and a projection extended inward of the socket, a downrod including a lower end secured to the ceiling fan housing, and including an upper end, and a ball secured to the upper end of the downrod, the ball including an outer peripheral portion having a first slot and at least one second slot formed therein for selectively receiving the projection of the bracket and for allowing the ball and the downrod and the ceiling fan housing to be rotated and adjusted relative to the bracket in a plane parallel to a plane of the ceiling of the building. The patterns provided on the outer peripheral portion of the ceiling fan housing may thus be adjustably and suitably supported and adjusted and directed toward the required angular position relative to the housings or the buildings, particularly relative to the side walls and/or the corners of the housings or the buildings.

The ball includes an upper portion and a lower portion, the first slot and the at least one second slot of the ball are extended from the upper portion toward the lower portion of the ball.

A light device is further provided and secured to the ceiling fan housing and includes two or more lamp shades rotatable and adjustable relative to the bracket by selectively engaging the projection of the bracket into either the first slot or the at least one second slot of the ball. The lamp shades may thus also be adjustably and suitably supported and adjusted and directed toward the required angular position relative to the housings or the buildings, particularly relative to the side walls and/or the corners of the housings or the buildings.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan view of a typical hanger support for the ceiling fan devices;

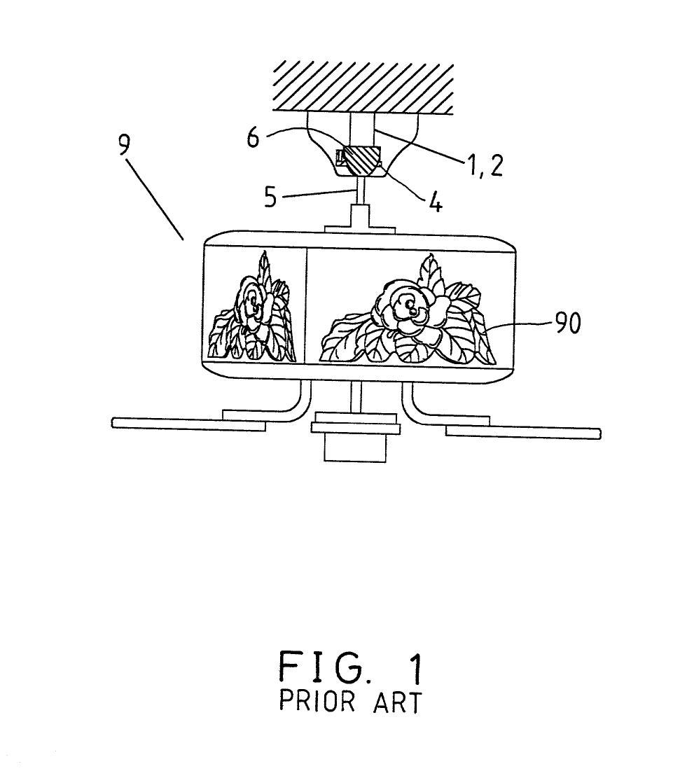

FIG. 2 is an enlarged partial cross sectional view of the typical hanger support for the ceiling fan devices;

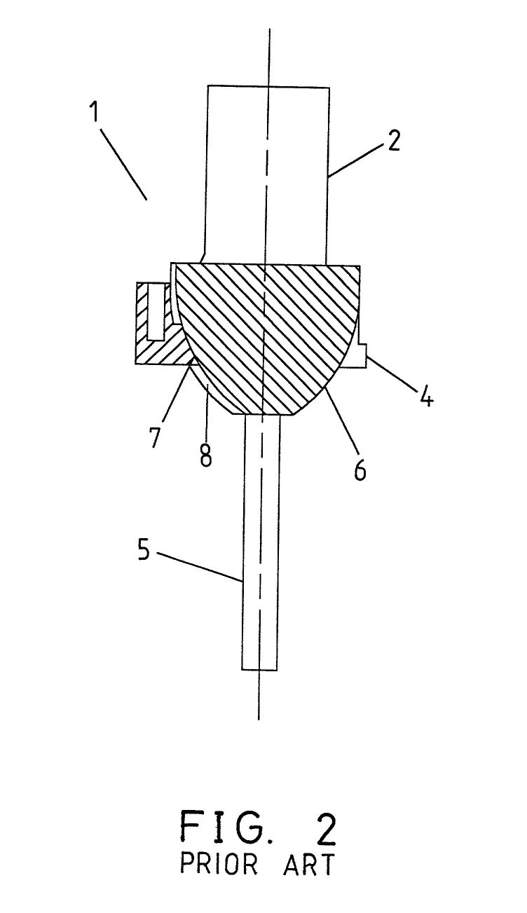

FIG. 3 is a partial exploded view of the typical hanger support for the ceiling fan devices

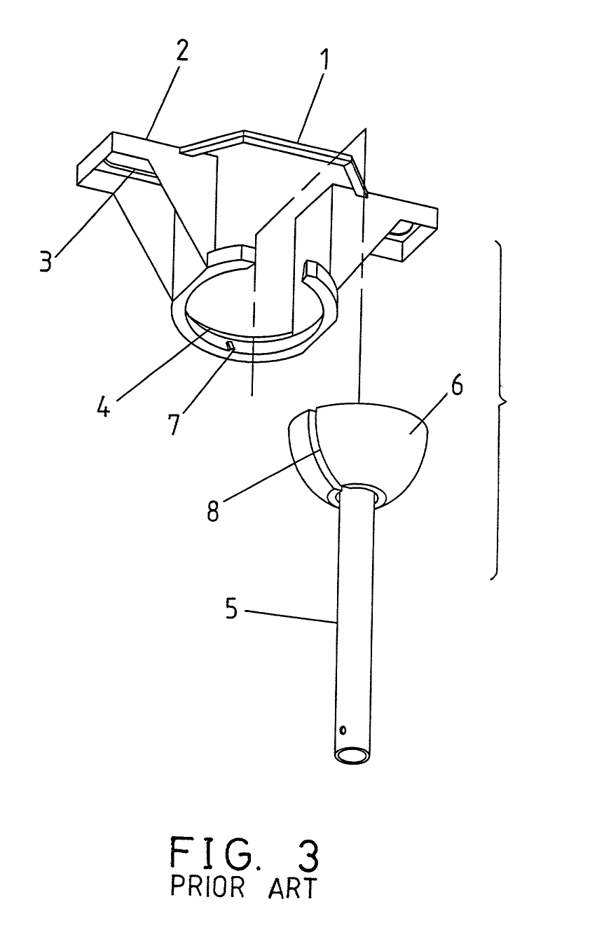

FIG. 4 is a plan view illustrating an adjustable hanger support for a ceiling fan assembly in accordance with the present invention;

FIG. 5 is an enlarged partial cross sectional view of the adjustable hanger support for the ceiling fan assembly in accordance with the present invention;

FIG. 6 is a partial exploded view of the adjustable hanger support for the ceiling fan assembly in accordance with the present invention; and

FIGS. 7 and 8 are plan views similar to FIG. 4, illustrating the operation of the adjustable hanger support.

### DETAILED DESCRIPTION OF THE PREFERRED EMBODIMENT

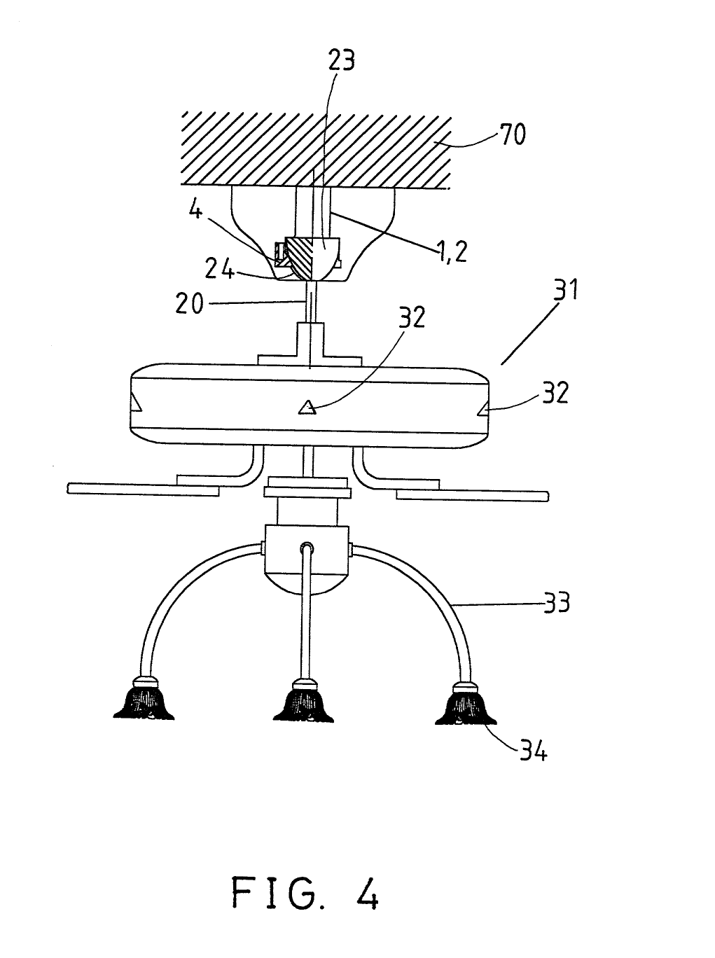

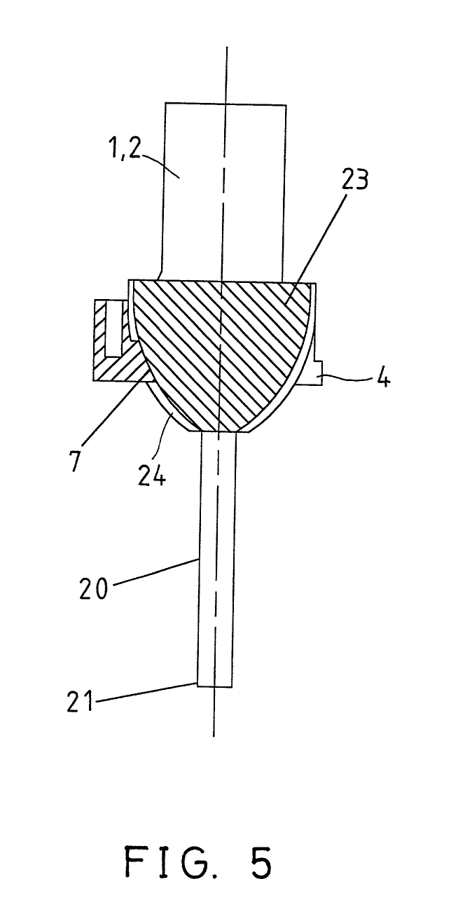

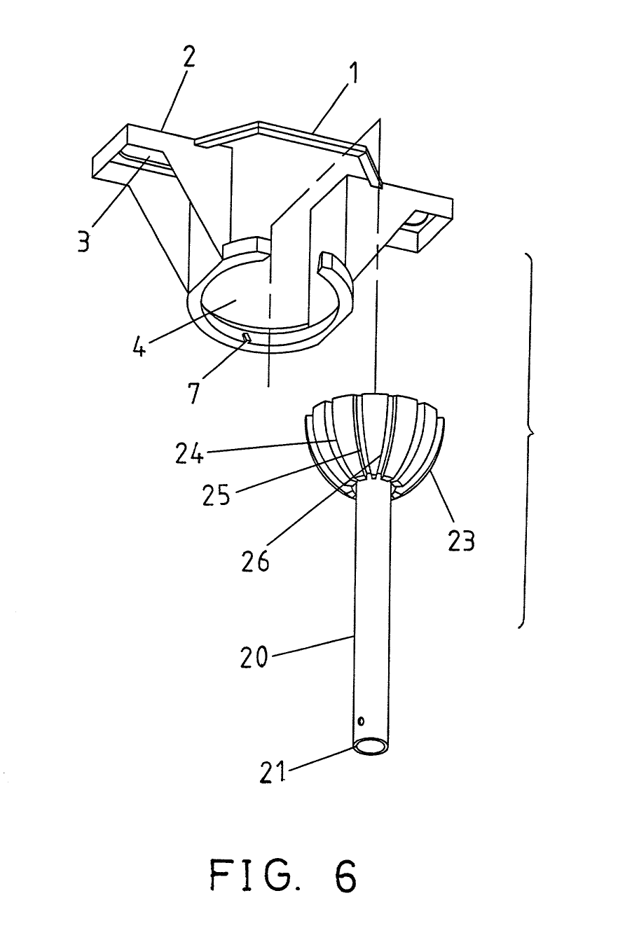

Referring to the drawings, and initially to FIGS. 4-6, an adjustable hanger support in accordance with the present invention is provided for adjustably and suitably supporting and securing a ceiling fan assembly to the required angular position relative to the housings or the buildings, particularly relative to the side walls of the housings or the buildings. The adjustable hanger support in accordance with the present invention also comprises a bracket 1 including two ears 2 extended laterally outward therefrom and each having an oblong hole 3 formed therein for receiving fasteners which may secure the bracket 1 to the ceiling 70 of the housings or of the buildings. The bracket 1 includes a ring or a socket 4 formed or provided in the bottom portion thereof, and includes a projection 7 extended inward of the ring or the socket 4. A downrod 20 includes a lower end secured to a ceiling fan housing 31 and includes a ball 23 secured is on top thereof. A light device 33 may further be provided and attached to the bottom of the ceiling fan housing 31, and includes three or more lamp shades 34 provided thereon or attached thereto. The above-described ceiling fan configuration is typical and will not be described in further details.

The ball 23 includes two or more slots 24, 25, 26 formed in the outer peripheral portion thereof and extended from the upper portion toward the lower portion thereof for selectively receiving the projection 7 of the socket 4 and for preventing the ball 23 and thus the ceiling fan housing 31 from rotating relative to the bracket 1 and the ceiling 70 in a horizontal plane parallel to the plane of the bracket 1 and the ceiling 70 of the housing or the building, and for allowing the ball 23 and the downrod 20 to be rotated and adjusted relative to the bracket 1 in a plane perpendicular to the plane of the bracket 1 or of the ceiling 70 or the like.

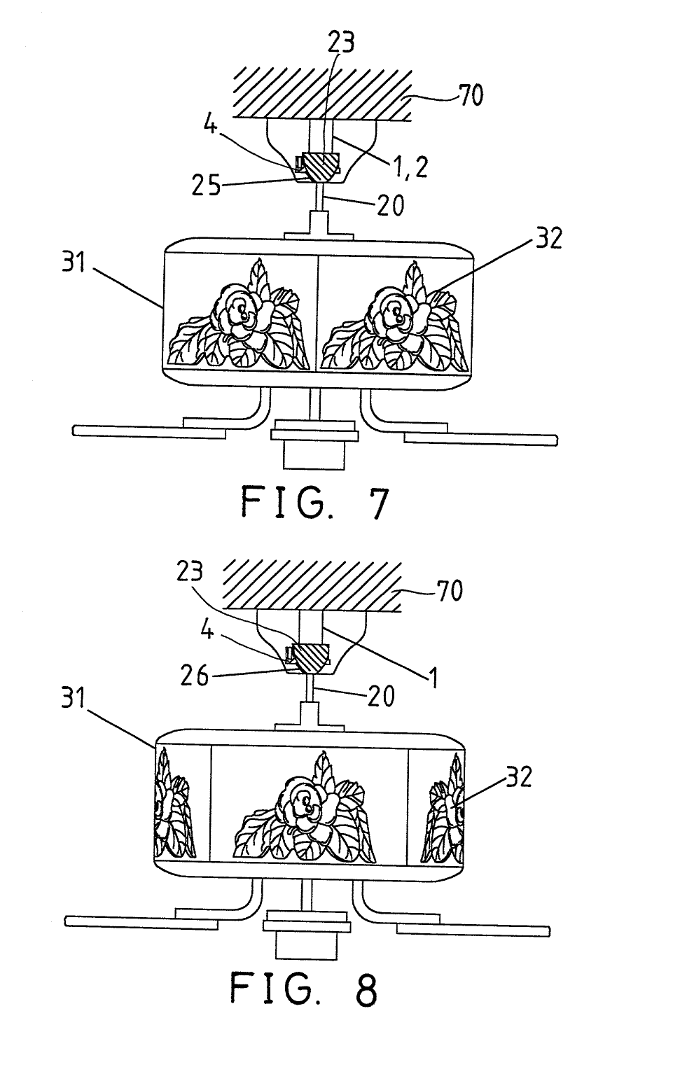

The two or more slots 24, 25, 26 of the ball 23 may be provided for selectively receiving the projection 7 of the socket 4, such that the ball 23 and thus the ceiling fan housing 31 may be rotated and adjusted relative to the bracket 1 and the ceiling 70 in the plane parallel to the plane of the bracket 1 and of the ceiling 70 of the housing or the building, and such that the patterns 32 provided on the outer peripheral portion of the ceiling fan housing 31 and the lamp shades 34 may be suitably adjusted and directed toward the required angular position relative to the housings or the buildings, particularly relative to the side walls of the housings or the buildings, best shown in FIGS. 4, 7, and 8.

For example, the ceiling fan assembly may include a light device (not shown) provided in the transparent or semi-transparent ceiling fan housing 31 for shining onto the patterns 32 provided on the outer peripheral portion of the ceiling fan housing 31 and for shining the patterns 32 onto the respective walls of the housing or of the building. The lamp shades 34 and/or the patterns 32 may thus be rotated or adjusted and directed toward the walls, for allowing the lights or the patterns to be adequately and plainly and flatly and smoothly shined onto the walls, and to be prevented from shining onto the corners of the housing or of the building.

Accordingly, the adjustable hanger support in accordance with the present invention may be used for adjustably supporting and securing the ceiling fan assembly to the required angular position relative to the housings or buildings.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ceiling fan assembly comprising:
a ceiling fan housing,
a bracket for attaching to a ceiling of a building, said bracket including a socket and a projection extended inward of said socket,
a downrod including a lower end secured to said ceiling fan housing, and including an upper end, and
a ball secured to said upper end of said downrod, said ball including an outer peripheral portion having a first slot and at least one second slot formed therein for selectively receiving said projection of said bracket and for allowing said ball and said downrod and said ceiling fan housing to be rotated and adjusted relative to said bracket in a plane parallel to a plane of the ceiling of the building.

2. The adjustable hanger support according to claim 1, wherein said ball includes an upper portion and a lower portion, said first slot and said at least one second slot of said ball are extended from said upper portion toward said lower portion of said ball.

3. The adjustable hanger support according to claim 1 further comprising a light device secured to said ceiling fan housing and rotatable and adjustable relative to said bracket by selectively engaging said projection of said bracket into either said first slot or said at least one second slot of said ball.
